(19) United States
(12) Patent Application Publication
(10) Pub. No.: US 2026/0131764 A1
(43) Pub. Date: May 14, 2026

(54) SHIELD APPARATUS FOR PROTECTING A WHEEL RIM

(71) Applicant: Michael Tyler, Napa, CA (US)

(72) Inventor: Michael Tyler, Napa, CA (US)

(21) Appl. No.: 18/941,611

(22) Filed: Nov. 8, 2024

(51) Int. Cl. B60S 3/04; B60B 7/00; B60B 7/10

(52) U.S. Cl. CPC B60S 3/042; B60B 7/0073; B60B 7/10

(57) ABSTRACT

A shield apparatus for protecting a wheel rim while treating a tire mounted on the rim includes a body which is sized and configured to cover the rim of the wheel. A plurality of clips is coupled to a front face of the body, and the clips are distributed along a circular path with a diameter such that the plurality of clips is configured to extend around the rim. The plurality of clips is configured to have a snap fit with the rim of the body. The shield apparatus may be mounted over the rim such that the rim is protected while spraying or otherwise applying a substance such as a shining solution or a cleaning solution on the tire.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to wheel rim covers and more particularly pertains to a new wheel rim cover for protecting a wheel rim while treating a tire mounted on the rim with a shining solution, cleaning solution, or the like.

### (2) Description of Related Art Including Information Disclosed Under 37 CFR 1.97 and 1.98.

The prior art describes various wheel rim covers for protecting the rim while treating a tire which is mounted on the rim. However, the prior art fails to describe such an apparatus in which clips engage the rim via a snap fit and in which a sealing member surrounds the clips such that the sealing member may conform to an exterior of the tire, sealing off the rim from an atmosphere adjacent to the tire.

### (h) BRIEF SUMMARY OF THE INVENTION

An embodiment of the disclosure meets the needs presented above by generally comprising a body which is sized and configured to cover the rim of the wheel. A plurality of clips is coupled to a front face of the body, and the clips are distributed along a circular path with a diameter such that the plurality of clips is configured to extend around the rim. The plurality of clips is configured to have a snap fit with the rim of the body.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a shield apparatus according to an embodiment of the disclosure.

FIG. 2 is a rear perspective view of an embodiment of the disclosure.

FIG. 3 is an exploded in-use view of an embodiment of the disclosure.

FIG. 4 is a side in-use view of an embodiment of the disclosure.

FIG. 5 is a cross-section in-use view of an embodiment of the disclosure taken from Line 5-5 in FIG. 4.

FIG. 6 is an in-use view of an embodiment of the disclosure.

### (J) DETAILED DESCRIPTION OF THE INVENTION

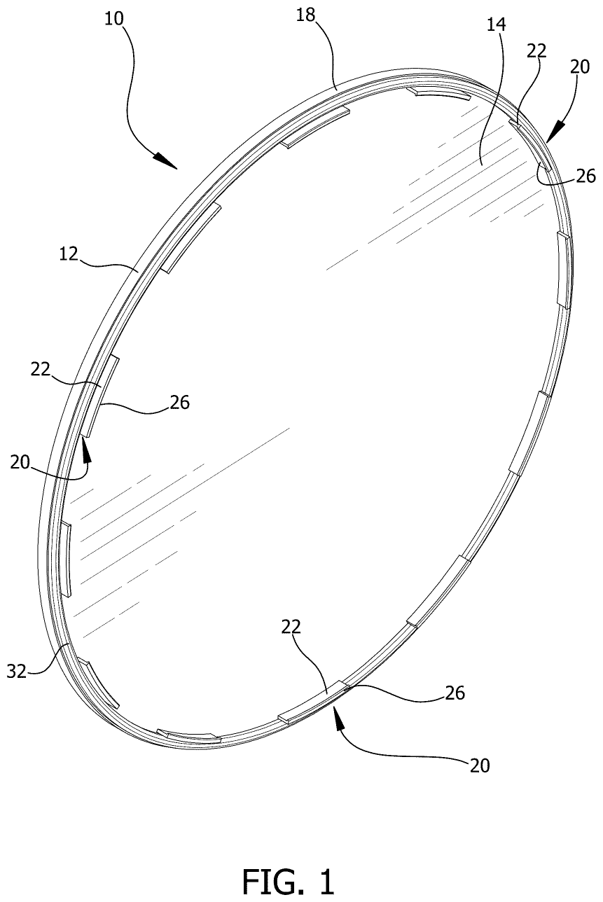

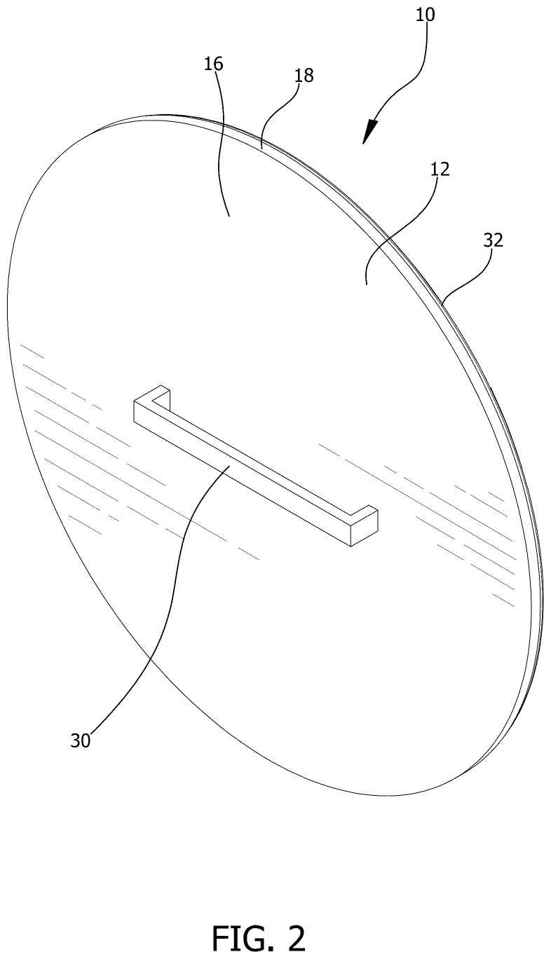

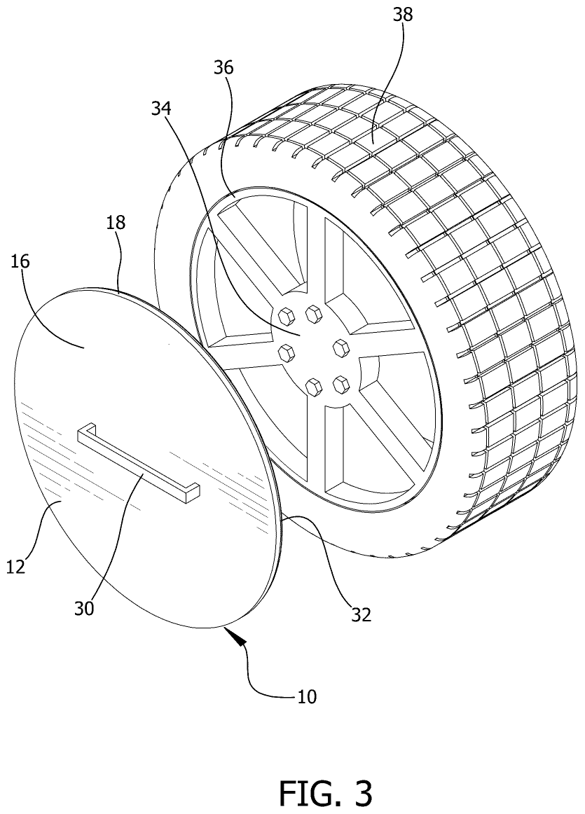

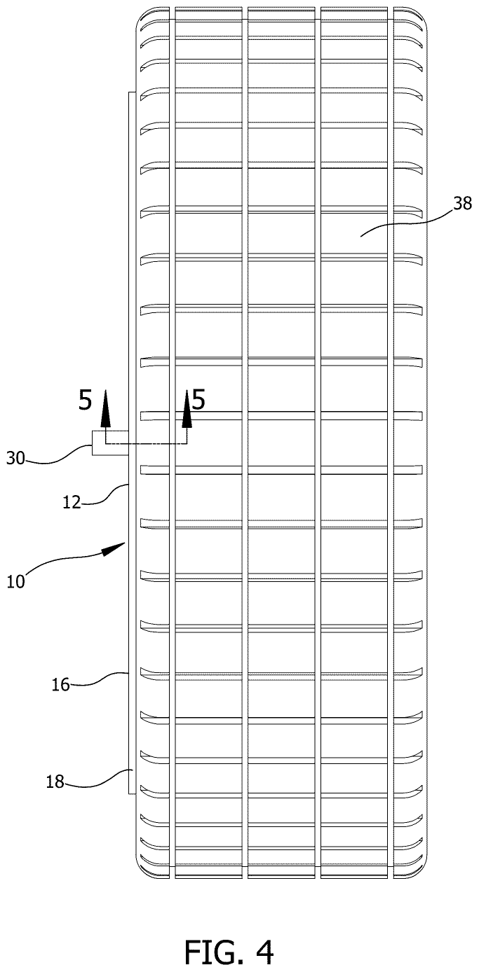

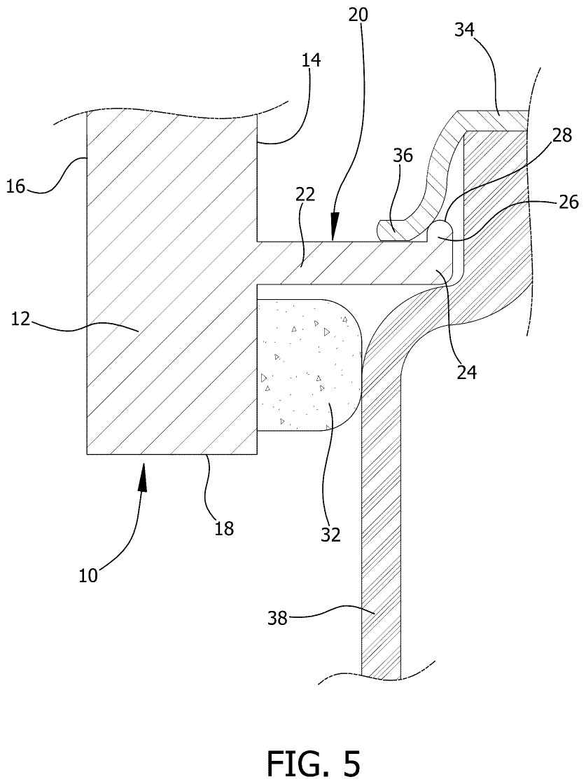

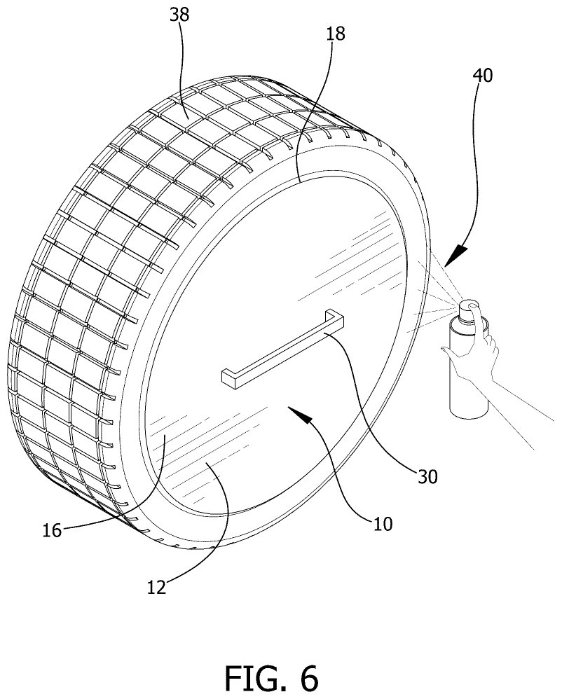

With reference now to the drawings, and in particular to FIGS. 1 through 6 thereof, a new wheel rim cover embodying the principles and concepts of an embodiment of the disclosure and generally designated by the reference numeral 10 will be described.

As best illustrated in FIGS. 1 through 6, the shield apparatus 10 generally comprises a body 12 which has a circular disc shape and is sized and configured to cover a rim 36 of a wheel 34. A plurality of clips 20 is coupled to a front face 14 of the body 12. The clips 20 are distributed along a circular path with a diameter such that the plurality of clips 20 is configured to extend around and attach to the rim 36. The circular path is positioned concentrically to a perimeter 18 of the body 12. The clips 20 are evenly spaced from each other around the circular path. A handle 30 is mounted on a back face 16 of the body 12.

Each clip 20 comprises an extension portion 22 which is coupled to and extends away from the front face 14 of the body 12 and a protrusion 26 coupled to the extension portion 22. The protrusion 26 is positioned adjacent to a distal end 24 of the extension portion 22 and protrudes inwardly with respect to the plurality of clips 20. The protrusion 26 has a convex surface 28 opposite the extension portion 22.

Each clip 20 comprises a resilient material such that the plurality of clips 20 is configured to have a snap fit around the rim 36. When pressed onto the rim 36, the rim 36 contacts the convex surface 28 of the protrusion 26 of each clip 20 which urges the extension portions 22 of the clips 20 outwardly. Then the extension portions 22 are resiliently urged inwardly to hook the protrusion 26 around the rim 36 when the protrusions 26 of the clips 20 are pushed beyond the rim 36. The body 12 may be detached from the rim 36 by pulling the body 12 away from the rim 36 with sufficient force to urge the clips 20 to bend outwardly again. The resilient material may be a plastic, a metal, a rubber, or the like.

The resilient material may be sufficiently soft such that the rim 36 is not scratched or marred during mounting and unmounting the body 12 to and from the rim 36 via the clips 20. In some embodiments a coating may be applied which is sufficiently soft not to mar the rim 36 instead or in addition to the resilient material being sufficiently soft. Either sufficiently soft material may be a plastic, a rubber, a silicone, or the like.

A sealing member 32 is coupled to the front face 14 of the body 12 and is positioned around the plurality of clips 20. The sealing member 32 is also positioned concentrically to the perimeter 18 of the body 12. The sealing member 32 comprises a deformable material such that the sealing member 32 is configured to form a moisture-impermeable seal with a tire 38 mounted on the rim 36. The deformable material may be a plastic foam, a rubber foam, a rubber, a silicone, or the like.

In some embodiments, the body 12, the plurality of clips 20, and the sealing member 32 may follow non-circular paths, especially in cases wherein the rim 36 follows a non-circular path. In particular, the clips 20 are arranged and shaped to be distributed around the rim 36. The shapes of the clips 20 may vary from what is described to attach to the rim 36 via the snap fit.

In use, the shield apparatus 10 is mounted over the rim 36 as described above via the clips 20. The handle 30 may be gripped to facilitate placement of the shield apparatus 10. A tire shining substance 40, a cleaning solution, or some other tire treatment product may then be applied to the tire 38 such as by spraying, dousing, brushing, wiping, or the like, and the body 12 will block the tire treatment product from reaching the rim 36. Therefore, the rim 36 will be protected from damage due to exposure to the tire treatment product. After treating the tire 38, the shield apparatus 10 may be removed by grasping and pulling the handle 30 with sufficient force to pull the clips 20 around and off of the rim 36.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A shield apparatus for covering a rim of a wheel during a tire treatment process, the shield apparatus comprising:
a body, the body being sized and configured to cover the rim of the wheel; and
a plurality of clips coupled to a front face of the body, the plurality of clips being distributed along a circular path with a diameter such that the plurality of clips is configured to extend around the rim, the plurality of clips being configured to have a snap fit with the rim of the body.

2. The shield apparatus of claim 1, wherein:
the body has a circular disc shape; and
the circular path of the plurality of clips is positioned concentrically to a perimeter of the body.

3. The shield apparatus of claim 2, further comprising a sealing member coupled to the front face of the body, the sealing member positioned around the plurality of clips, the sealing member positioned concentrically to the perimeter of the body, the sealing member comprising a deformable material such that the sealing member is configured to form a moisture-impermeable seal with a tire mounted on the rim.

4. The shield apparatus of claim 1, wherein the clips of the plurality of clips are evenly spaced from each other.

5. The shield apparatus of claim 1, wherein each clip of the plurality of clips comprises:
an extension portion coupled to and extending away from the front face of the body;
a protrusion coupled to the extension portion, the protrusion being positioned adjacent to a distal end of the extension portion and protruding inwardly with respect to the plurality of clips, the protrusion having a convex surface opposite the extension portion; and
wherein the clip comprises a resilient material such that the plurality of clips is configured to have the snap fit around the rim.

6. The shield apparatus of claim 1, further comprising a sealing member coupled to the front face of the body, the sealing member positioned around the plurality of clips, the sealing member comprising a deformable material such that the sealing member is configured to form a moisture-impermeable seal with a tire mounted on the rim.

7. The shield apparatus of claim 1, further comprising a handle mounted on a back face of the body.

8. A shield apparatus for covering a rim of a wheel during a tire treatment process, the shield apparatus comprising:
a body, the body being sized and configured to cover the rim of the wheel, the body having a circular disc shape;
a plurality of clips coupled to a front face of the body, the plurality of clips being distributed along a circular path with a diameter such that the plurality of clips is configured to extend around the rim, the circular path being positioned concentrically to a perimeter of the body, the plurality of clips being evenly spaced from each other, each clip of the plurality of clips comprising:
an extension portion coupled to and extending away from the front face of the body;
a protrusion coupled to the extension portion, the protrusion being positioned adjacent to a distal end of the extension portion and protruding inwardly with respect to the plurality of clips, the protrusion having a convex surface opposite the extension portion; and
wherein the clip comprises a resilient material such that the plurality of clips is configured to have a snap fit around the rim;
a sealing member coupled to the front face of the body, the sealing member positioned around the plurality of clips, the sealing member positioned concentrically to the perimeter of the body, the sealing member comprising a deformable material such that the sealing member is configured to form a moisture-impermeable seal with a tire mounted on the rim; and
a handle mounted on a back face of the body.
